(19) United States
(12) Patent Application Publication
(10) Pub. No.: US 2010/0228578 A1
(43) Pub. Date: Sep. 9, 2010

(54) SEAMLESS GLOBAL ASSISTANCE

(76) Inventor: Jitendra Varma, Greater Noida (IN)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/483,806

(22) Filed: Jun. 12, 2009

(30) Foreign Application Priority Data
Mar. 6, 2009 (IN) 440/DEL/2009

(51) Int. Cl. G06Q 50/00; G06Q 10/00; G06Q 30/00

(52) U.S. Cl. 705/6; 705/14.16; 705/9; 705/26; 705/10; 705/5

(57) ABSTRACT

The subject matter described herein includes methods and systems for providing seamless global assistance to travelers. According to one method, pre-travel services are provided to travelers through client interaction devices. Customized assistance is provided during travel. Post-travel services are also provided to the travelers. The global assistance is provided by seamless transformation of virtual assistance into physical assistance.

### RELATED APPLICATIONS

This application claims the benefit of Indian patent application No. 440/DELU2009 filed Mar. 6, 2009, the entire disclosure of which is herein incorporated by reference.

### FIELD OF THE INVENTION

The instant invention generally relates to a method and system to provide assistance to business travelers and tourists. More particularly, the present invention relates to a method and system to provide such assistance to business travelers and tourists virtually as well as in real time through a seamless transition.

### BACKGROUND OF THE INVENTION

In this age of globalization there is both a continuing opportunity and need for business travelers as well as tourists to visit places around the globe. The international travel has been on constant rise since last two decades. The rise in international travel can be attributed to ever increasing global business. Also with the continuous increase in the disposable income of the common man, more and more people plan their excursions on an international level. The traveler from a developing nation with its uninformed tourists and immense language problem and traveler from developed nation with their inability to feel safe and secure without a local help defines the current problem of tourism sector.

To make traveling convenient and comfortable various tourist/traveler assistance models/systems have been proposed in the related art. Such models provide information and assistance to a tourist/traveler.

In related art we find a “communication and telephone assistance system” which provides for a direct communication medium with an integral traveler service centre providing translation service, information both verbal or through text format and connectivity to the service providers through the help of a mobile phone to traveler. However such arrangements are only a telephone exchange between the traveler and the service centre. It doesn't provide for call between traveler and the third party when the call is routed through the service centre. It only serves as a call centre. This system does not envisage a portal. Also it does not envisage a real time physical assistance system. Also, the entire assistance is dependent on the request of traveler. In case of emergency, a traveler may not be in a position to call for help. It does not assist in any emergency. The entire assistance is dependent on the request of the traveler.

However, the present invention allows any person on behalf of the needy traveler to call for assistance. In essence the invention allows for a suo moto assistance in case such a need arises and provides for a wider umbrella of assistance through IT and franchisee system.

Thus there is a long felt need to have a generic solution in the form of an assistance package that integrates on-line information and support system with real-time assistance through telecommunication and physical help.

### SUMMARY OF THE INVENTION

To achieve these objectives the present invention describes a method and system for providing assistance to travelers virtually as well as in real time.

An embodiment of the invention integrates on-line information and support system with real-time assistance through telecommunication and physical help in the form of franchisee system.

Another embodiment of the present invention provides language support to the traveler in case of need.

Another embodiment, of the present invention provides local physical help to the traveler.

In another embodiment of the present invention the system and method provides timely information to the traveler.

In another embodiment of the present invention the system and method provides an effective feedback to the government about the place travelers' visit and their problems, thus helping the government to frame future tourism policies.

Another embodiment of the present invention provides for a comprehensive single-window comfort and Telecommunication and Information Technology services for assisting travelers.

Another embodiment of the present invention provides for a single button instant hotline to the call centre wherein the communication network is provided by the local service provider Another embodiment of the present invention provides for assistance in case of lost mobile/communication device wherein the traveler may call from the real time traveler assistance kiosks scattered across the touring destination.

A yet another embodiment of the present invention provides assistance by way of a unique identification /transaction smart card.

### BRIEF DESCRIPTION OF THE ACCOMPANYING DRAWING(S)

The proposed method and system is described with reference to the accompanying figures. In the figures, the left-most digit(s) of a reference number identifies the figure in which the reference number first appears. The same numbers are used throughout the drawings to reference like features and components.

FIGS. 1A & 1B illustrate a System overview of the present invention.

FIG. 2 illustrates an exemplary architecture for implementing a preferred embodiment of the present invention.

### DETAILED DESCRIPTION OF THE INVENTION

Systems and method for efficient means of providing assistance to travelers virtually as well as in real time through a seamless transition are described. The description of the system or method shown herein below is intended only for illustration and disclosure of an operative embodiment and not to show all of the various forms or modifications in which this invention might be embodied or operated, since the same may be modified in various particulars or relations without departing from the spirit or scope of the claimed invention.

For a nominal fee any traveler can register for the service. With his registration, the current service platform will create a database with all relevant information like language, food preference, credit card details, blood group, allergies and other medical information for emergencies, the tourist will receive a mobile phone as soon as he lands in India. The telephone will have some emergency numbers pre-fed for speed dialing.

The current service platform will also constructs traveler assistance booths all over the world which can be used as points of physical contact for the travelers, providing information and assistance as well as well-equipped restrooms, internet access and even refreshments. For each destination, there is a central point and several booths all over the destination.

The present invention provides a generic solution by creating a seamless interface between virtual and real traveler assistance. It takes care of all the major apprehensions that a traveler has while traveling in an unknown country.

The instant invention provides timely information to the traveler, an effective feedback system to the government about a destination's traveler's and its problems, helping it in framing future tourism policies.

The instant invention provides for a seamless approach to multiple destination/country travel. This is achieved by providing a single registration, smooth switchover from one country office to another etc. All this can be achieved through a single call centre

The platform of the present invention is truly global as it even covers remote areas. Thus it can be used to promote new destinations which were not so popular with travelers.

Further, the instant invention comes in the form of series of services. For example, traveler gets uniform courtesy, services and responses all across the globe, instilling confidence in travelers who are venturing into not so frequented, remote but exotic locales.

The instant invention provides for a centralized multi-lingual call centre handling all the information from a centralized databank instead of having traveler information call centre in every country. In fact the traveler can call from the traveler assistance kiosk and have a video conferencing with the person speaking in the traveler's language and also a transcription may be in English for the help of the kiosk owner to understand the situation and get help to the traveler. Calls are not free of cost. The user will pay for a local call, when he calls the call centre wherever it is situated on the globe.

The ability of the call centre personnel trained to talk to the third party for sorting out the issues is efficiently handled in the instant invention. The traveler may either dial the call centre and after explaining the case to the call centre person in their native language can be put on a four point conference call with the local kiosk manager, local third party service provider, call centre personnel and the traveler sorting the issue or it can walk into a information kiosk where the local kiosk manager sorts the issue at his level.

The instant invention also connects to any communication device and may help the traveler call anywhere. Also information packets as and when needed by the traveler can be mailed to his e-mail ID or SMSed to his mobile no.

The software of the instant invention will not only enable to identify the location of the caller but would also enable the system to throw up possible service providers and product vendors in the proximity who may attend to the needs of the callers.

The present invention in particular provides these and many more features.

In essence the present system is a real time, seamless delivery system of a bouquet of services to any traveler on the globe to enhance his sense of security, increase in pleasure quotient and remove his fear of unknown. Every tourist should have one window for meeting all his needs everywhere in the world.

It is a uniquely designed service platform, which creates a synergy among various industries into a seamless delivery system, for services in hospitality sector, with its own proprietary global data bank, a multilingual BPO/call center, a universal call number and a string of franchisees for seamless network of services by area level trained field agents.

Further, the service platform will provide instant access to the worldwide database and alternative solutions to every change in the schedule, with topical information on day-to-day basis about the visit ability of the place of visit as well as flexibility to the tourist to design his own itinerary.

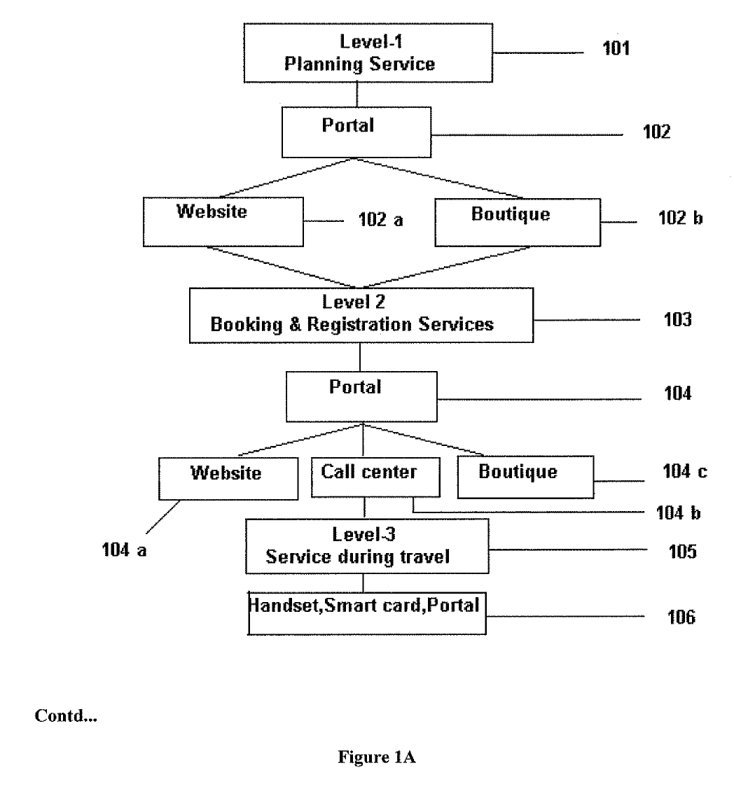

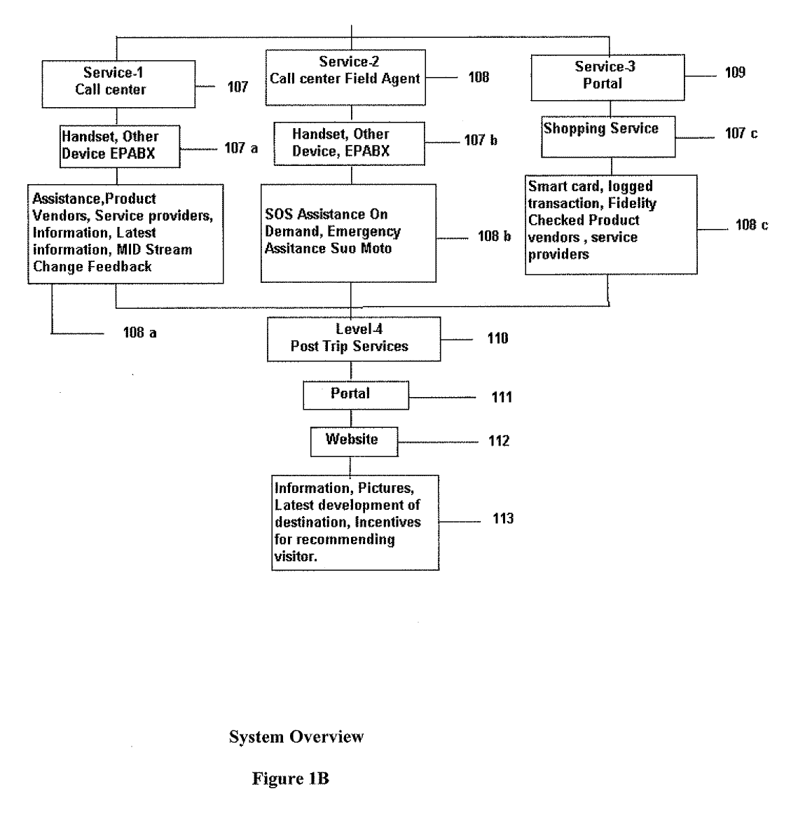

Now, referring to FIGS. 1A & 1B for explaining the present invention from a System overview.

The services provided by the present business model can be broadly classified as follows:

1. Level 1, Planning Service [101]

2. Level 2, Booking & Registration Services [103]

3. Level 3 Service during travel [105]

4. Level 4 Post trip services [109]

Level 1, Planning Service [101] comprises host of services that a traveler can use before actually starting his/her excursion on a foreign land. One such planning service may be planning a customized itinerary for the traveler.

Planning services can be accessed though a portal [102] which could connect to a website [102a] and/or boutique [102b].

Similarly, Booking & Registration Services [103] at level 2 can also be accessed through a portal [104]. In different embodiments the portal [104] is connected with a website [104a], call centre [104b] and/or boutique [104c].

At level 3, Service during travel [105], the traveler has access to a handset, smart card and/or portal [106]. Using these tools, in an embodiment to provide assistance service [107] the traveler connects with a call center. As mentioned the tool used could be handset and/or EPABX [107a]. The services offered comprise assistance, product vendor and/or service provider information, mid stream change feedback.

Similarly in another embodiment of the service, a call centre field agent [108] can be reached through a handset and/or EPABX device [107b]

Another such service during travel [105] can be accessed through a portal [109] and the service provided could be shopping [107c]. Also, such services are enabled through smart card, logging corresponding transactions, fidelity check for product vendors and service providers [108c].

Level 4, Post Trip Services [110] can be accessed through a portal [111] and/or a website [112]. Such post trip services comprise information, pictures, latest development with regard to destination, incentives for recommending visitors etc.

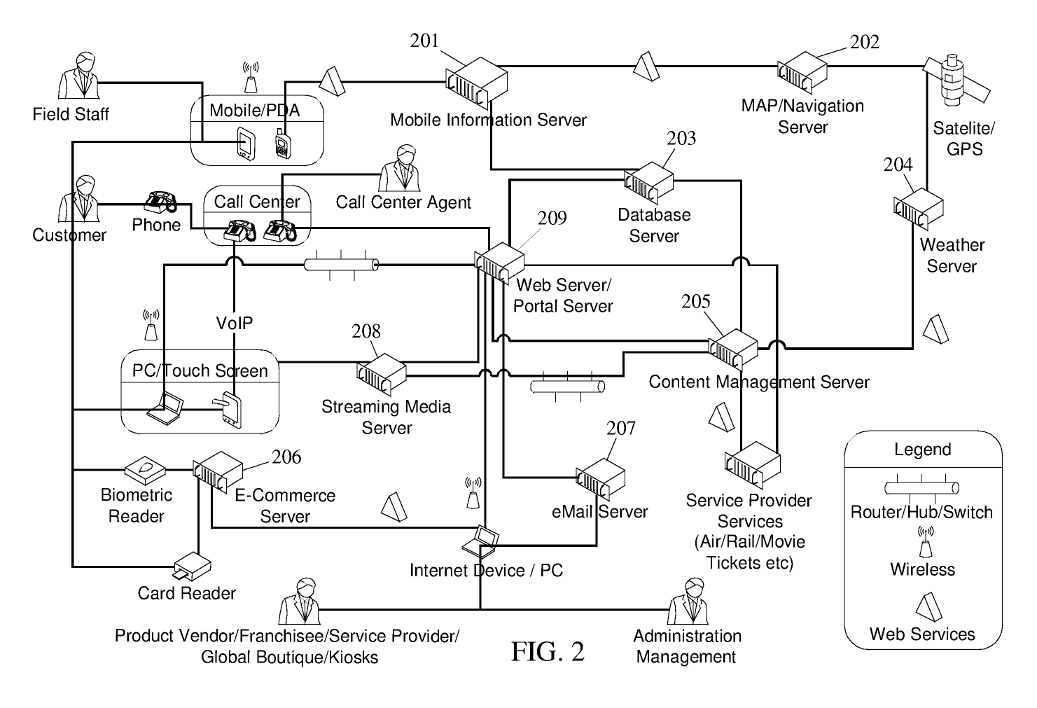

Now referring to FIG. 2 for explaining an embodiment of the hardware architecture of the present invention.

A mobile information server [201] is used to render data on mobile devices. The mobile information server [201] is also connected to a backend system to retrieve additional data for mobile devices.

The Map/Navigation Server [202] is used to retrieve data about Maps/Navigation system and provides additional information about the destination, location of service providers and product vendors and visitors.

Also, at least a data base server [203] is used to keep business rules, business data, and critical user information, their schedules, service provider information and endpoints. This shall act as a key location to look up all information or links to the information.

A weather server [204] is used to retrieve weather information. The weather server will contain static historic weather information

Similarly content management server [205] manages and/or contains static data/graphics, small video/audio.

The e-commerce server [206] is used to manage various transactions of the system.

A standard e-Mail server [207] is used for staff/customers/management.

A Streaming Media server [208] is used to retrieve multimedia information (audio and/or video) of the site/location/place where the user is about to visit. The streaming media server [208] will also provide historical information about the site in audio/video format.

A standard web server/portal server [209] containing data/information about the websites/portal, the features/services offered.

Still referring to FIG. 2, the data/information flow in the present system is explained in detail hereunder.

An end user/tourist/agent can make use of various digital gadgets available to communicate and retrieve information from the services of the present system.

In an embodiment, the gadget used is a WAP (Wireless access protocol) enabled Smart phone/PDA which can be successfully used to connect to the available services.

A user can use his/her WAP device to browse the web pages from either the Web server or he can download a mobile application which can be used to browse various data from Mobile Information Server [201]. The information provided by the mobile information server [201] comprises of:
traveler's personal information
his itinerary information and daily schedule/routine.
The weather information of a particular schedule/routine
The local information of a particular city that may be of use to the traveler e.g. various cultural activities going on in a particular place/city.
Allowing change/amendment of travel schedule

The Content Management Server [205] frequently updates the Weather content in the database by retrieving information from the Weather Server. During request from the user's WAP device, our EC Mobile Application connects to the MIS. For weather requests the MIS will talk to the database server to retrieve weather information from the database.

Similarly, the MIS is directly connected to the MAP/Navigation Server [202] (GPS) which can provide enough navigation information and this information is further pushed to the tourist's device in combination with the rich services offered by eCon at the place which is on the MAP.

We also have Streaming Media Server [208] which contains information in AudioNideo format; every location on the MAP mentioned above can have Hotlinks. A HotLink is a link which pops up itself on the MAP when some information is explored by the user on his internet enabled device. As the same information will also be available offline, the Hotlink can also popup if the user is browsing the offline media supplied by eCon.

Once the HotLink is clicked then if the link is about Media, the Smart Device immediately connects to our Streaming Media Server for Streaming of Data relevant to the HotLink.

All our servers including Streaming Media Server and the database is tightly integrated with each other to provide accurate and all available information in the quickest time.

The hotlink can map to the Still Image content as well which is located on the content management server.

Also there is an e-Commerce server which does the transactions. A transaction can be initiated either by the service provider or our eCon Agent or by the customer as well. The e-Commerce server is connected to EC Web Server and Service Provider servers to facilitate various transactional services.

Following are the various features and/or advantages of the present invention.

Assurance

Assistance in all situations by way of a unique identification/transaction smart card.

The services include:
1. Planning
2. Arrangement of Transport/Travel
3. Arrangement of Accommodation
4. Crisis Management
5. Providing up to date information
6. Arranging support logistics
7. Shopping
8. Procedures/Coordination with local authorities

Delivery support systems
1. Web-site—Contains data on traveler, places or services, events, specific situational information
2. Call Center—Personal delivery of information
3. Real time support services—Local representative
4. Network support for assured quality of services and products

Uses of the platform
1) Web site
(a) Anyone
   i) Basic information about
      a) e-Con
      b) Futuron Synergie
      c) Each country separately
      d) Information about tourism
         Travel
         Hotels
         Transport
(b) Registration on line
For registered users
   (i) Travel plan organizer
   (ii) Reservation tie-ups
   (iii) Designer itinerary
   (iv) Current/area specific information update frequency
   (v) Information on request
      Shopping place
      Doctor Hospital
      Other Contingencies/emergencies
   Web site for
   Franchisees/e-con Staff
   Exchange of business details
   Internal communication
   Transaction details
   VOIP interaction
   (c) Data bank on
   Service providers/call center
   Product venders/Registered uses
   Tourist inflow//—(a) & (b)
2. Call center
   a) Universal call centre for dial up
   b) Providing Information to tourists+Service Provider+Product vendors+Franchisees or E Con agents
   c) Situation response
   d) Value based service
      Reorganizing program
      Alternative option providing
   e) Communicating with traveler in his own language
3. Real Time Support Services
   a) Franchisee/E-con staff
      Input: Call Center, Direct
   b) Coordination with Service providers
      Product vendors
      Local authorities
   c) Fidelity check for all SP/PV for quality/reliability
   d) Inputs about the locality
Day to day current
   f) Information about events/festivals/places people
   g) Geo-positioning etc./digital mapping
4) Networked support for QA, reliable transactions & shipment/delivery assurance

Seamless Network

Client side application is taken care of by business components, business services, compatibility with other software and through future up gradations too.

The components are specially designed to plug wherever and whenever required.

Web services have been extensively used to take care of diverse clients.
a) Registered customers
b) Our agents
c) Third party people
d) Our own software components
e) Third party software components

The registered clients can connect to the services through:
1. A desktop computer
2. The Internet
3. PDAs (Personal Digital Assistant), Smart Phones

In one embodiment the clients may have Bluetooth enabled systems. The components are designed in a way to identify the type of clients described above. Also if the channel requires any specific client then it may be specified. There are proper channels through which the clients access servers.

Because of distributed nature of clients data will transferred through the internet, The architecture has different types of servers forming a chain. The whole system is built on both SCALE-OUT and SCALE-UP concept. Servers will be added as and when required and so load balancing will also be required.

The exact load balancing approach depends upon the type of servers available in the market.

There is special software or modules for desktop clients. Desktop clients are those clients which connect to the servers provided in the instant invention not through the web-browsers.

What is claimed is:

1. A method for providing global assistance to travelers, the method comprising:
providing pre-travel services to the travelers through client interaction devices;
providing customized assistance during travel;
providing post travel services to the travelers;
wherein the global assistance is provided by a seamless transformation of virtual assistance into physical assistance.

2. A method as claimed in claim 1 wherein an embodiment of the method comprises the steps of:
registering travelers through a portal;
booking an excursion for the travelers;
planning a schedule for each traveler;
visiting locales decided upon as per the schedule;
contacting the portal;
locating position of the traveler; and
providing virtual and physical assistance to the traveler.

3. A method as claimed in claim 1 wherein the pre-travel services are provided through web portals and/or global boutiques, the pre-travel services comprise:
providing booking and registration services to the travelers on the client interaction device; and
planning schedule for the travelers.

4. A method as claimed in claim 1 wherein the customized assistance during the travel comprises:
providing a wireless device to each traveler with call centre connectivity for virtual assistance;
providing an electronic card to each traveler;
providing updated information to each traveler; and
providing on-demand physical assistance.

5. A method as claimed in claim 1 wherein the post travel services comprises.
providing information related to latest development of visited destination; and
providing incentives to the traveler for recommending visited destination to other potential travelers.

6. A method as claimed in claim 3 wherein the planning schedule comprises:
providing a travel plan organizer in the form of a designer itinerary;
arranging transport for the traveler;
arranging accommodation for the traveler;
arranging support logistics for the traveler; and
providing up to date information on request.

7. A method as claimed in claim 6 wherein the information comprises various attributes such as providing information about places of shopping; providing information about medical institutions and providing information about other emergencies and contingencies.

8. A method as claimed in claim 1 wherein the seamless transformation is achieved through synergy between Information technology network and local franchisee system.

9. A method as claimed in claim 4 wherein the wireless device is a mobile phone provided by a local mobile service provider, the mobile phone having at least a single dedicated button for forming an instant communication with the call center.

10. A method as claimed in claim 4 wherein the call centre is a multilingual call centre, providing assistance by handling information through a central databank wherein the method of providing assistance comprises the steps of:
the traveler contacting the call center;
the call centre personnel assisting the traveler in traveler's native language;
the call centre personnel putting the traveler in a conference call with other assistance providing entities.
The call centre providing a communication link between the traveler and the real time agent for physical assistance.

11. A method as claimed in claim 4 wherein the electronic card comprises:
a) at least a money pouch apart for carrying information about the traveler in digital form.
b) at least a debit card, allowing the traveler to make on line transactions

12. A method as claimed in claim 4 wherein the updated information comprises alerts, schemes, incentives, warnings and weather information.

13. A method as claimed in claim 4 wherein the physical assistance to the traveler is provided through franchisees, local staff etc.

14. A method as claimed in claim 10 wherein the services provided by multilingual call centre comprises:
providing relevant information to tourists, service providers, product vendors, franchisees and/or agents;
providing value based service(s) like reorganizing program and alternative option providing;
providing communication with traveler in the traveler's language;
providing services to the stake holders.

15. A method as claimed in 14 wherein the services can be provided through sms, email, text from WAP enabled website and through placing calls.

16. A method as claimed in claim 14 wherein the stakeholder is government and the services provided comprise:
providing statistical information to the Government;
providing destination information for policy planning;
providing details of services provided and;
providing a satisfaction index as a measure of satisfaction of traveler.

17. A method as claimed in claim 10 wherein the assistance can be provided by the call centre even when the call centre is contacted by a person other than the registered traveler.

18. A method as claimed in claim 11 wherein the online transactions comprise:
a) on the spot purchases;
b) deducting cash.
